(19) United States
(12) Patent Application Publication
(10) Pub. No.: US 2026/0225083 A1
(43) Pub. Date: Aug. 6, 2026

(54) MANGANESE COMPOSITIONS, USES AND PRODUCTION

(71) Applicant: Infinite Water Technologies Pty Ltd, Sydney, New South Wales (AU)

(72) Inventors: Gheorghe Emil Duta, Sydney, New South Wales (AU); Kalaruban Mahatheva, Sydney, New South Wales (AU)

(21) Appl. No.: 19/152,421

(22) PCT Filed: Jan. 31, 2024
(86) PCT No.: PCT/AU2024/050057

§ 371 Date: Jul. 30, 2025

(30) Foreign Application Priority Data
Jan. 31, 2023 (AU) 2023900224

(51) Int. Cl. B01J 23/889; B01J 35/40; B01J 35/61; C02F 1/72

(52) U.S. Cl. CPC B01J 23/8892; B01J 35/40; B01J 35/613; C02F 1/725; C02F 2305/023

(57) ABSTRACT

Provided herein are compositions comprising manganese or an oxide thereof and processes for their production. In particular, the present disclosure relates to compositions comprising manganese or an oxide thereof, iron or a cationic species thereof, and an oxidizable metal, and also to compositions comprising an oxide of manganese, a cationic iron species, and a cationic metal species. The present disclosure also relates to the use of such compositions, especially in water treatment.

### RELATED APPLICATION

This application claims the benefit of Australian Provisional Patent Application No. 2023900224, filed on 31 Jan. 2023, which is incorporated herein by reference in its entirety.

### TECHNICAL FIELD

The present disclosure relates to compositions comprising manganese or an oxide thereof and processes for their production. In particular, the present disclosure relates to compositions comprising manganese or an oxide thereof, iron or a cationic species thereof, and an oxidizable metal, and also to compositions comprising an oxide of manganese, a cationic iron species, and a cationic metal species. The present disclosure also relates to the use of such compositions, especially in water treatment.

### BACKGROUND ART

Many industrial processes produce significant quantities of waste water containing various contaminants which need treatment prior to release. It is also necessary for water streams used in many industrial applications to contain limited quantities of particular contaminants, including organic contaminants. Drinking water must contain less than a threshold level of various contaminants including organic contaminants.

While water is a naturally-renewable resource through the rainwater cycle, water from rainwater catchments does not always arrive at domestic and industrial usage points in pure form, but rather it can collect contaminants as it travels from a catchment through water supply infrastructure. Also, renewable rainwater is not always plentiful, but rather depends on environmental factors such as geographical area, seasonal changes and weather events such as drought. Water recycling is accordingly a focus area, but water sources for recycling often contain levels of contaminants that make it unsuitable to be repurposed, especially as drinking water.

For instance, heavy rain can bring into rivers and catchments natural organic matter (NOM) and especially after a forest fire has occurred in a catchment area. There is also an increasing amount of organic pharmaceutical, household chemical and personal care compounds in municipal wastewater streams. Organic herbicides and pesticides are being more heavily used and higher amounts are being found in agricultural run-off. Municipal and industrial wastewater streams can also contain many other-often toxic-contaminants. Also, organic microplastics are being found in water bodies in increasingly concerning concentrations.

Water treatment processes for reducing contaminant levels are accordingly becoming increasingly important, especially for producing drinking water.

Known water treatment processes for reducing contaminant levels, including organics, generally rely on advanced oxidation processes (AOPs) together with mineralisation. For organic contaminants, essentially this works to break down organic compounds into carbon dioxide, water and inorganic salts that can be precipitated or filtered out. AOPs which rely on catalysts are known as Catalytic Advanced Oxidation (CAO) processes.

AOPs typically rely on the production of the hydroxyl radical. The hydroxyl radical is a powerful oxidant which can degrade organic molecules by hydrogen abstraction and insertion at carbon-carbon double bonds. Different types of AOPs are known which differ in their generation of the hydroxyl radical.

The first AOP was based on Fenton Reagent and involves the production of hydroxyl and hydroperoxyl radicals in a disproportionation reaction of hydrogen peroxide with metal ions in two oxidation states. The classical example involves ferrous and ferric iron, but manganese is also common.

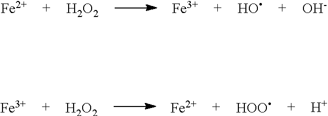

Another type of AOP involves superoxide and uses metal oxide catalysts to produce hydroxide ions from water and decompose unstable oxidants such as sodium hypochlorite, permanganates, peroxides and ozone into atomic oxygen, which react together to form superoxide and hydroperoxyl radicals. Both superoxide and the hydroperoxyl radical can oxidise organic compounds. Superoxide can also react to produce hydrogen peroxide which can then form hydroxyl and hydroperoxyl radicals in Fenton chemistry as exemplified above with metal ions of the catalyst.

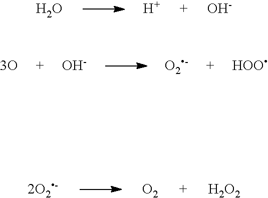

Ozone-based AOPs are also known which do not require a metal catalyst.

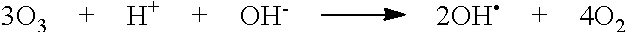

Photoinitiation AOPs are also known for the production of hydroxyl radicals from ozone and hydrogen peroxide.

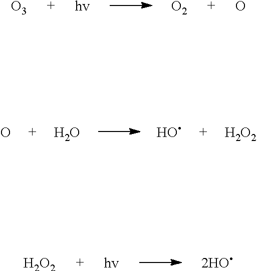

Electrochemical AOPs are also known which use an electrochemical cell in which the water to be treated serves as the electrolyte (usually with additives) and a voltage is applied to a cathode to produce oxidants such as hydroxyl radicals and ozone at the anode.

There remain several limitations to the known water treatment processes for reducing contaminant levels, including organic contaminants.

The consumption of chemicals is high with AOPs based on Fenton chemistry, and maintaining the conditions for usable process performance is difficult. Hydrogen peroxide is also expensive and so costs are high. The superoxide process requires contaminant compounds to be charged to be attracted to the catalyst to be oxidized, and as such is limited in its applicability to particular contaminants, including organics. Ozone-based processes tend to be less effective, resulting in intermediate fragmentation of organic compounds rather than mineralisation. This can lead to biofouling downstream and treated water still often requires biological filtration. High pH is also favoured but this tends to promote formation of bicarbonates which scavenge hydroxyl radicals. In photoinitiation processes absorption of UV by hydrogen peroxide is low and an excess of hydrogen peroxide is needed, and UV irradiation is lost through absorption by water, so these processes are inefficient and become costly. Electrochemical AOPs are limited to specific types of organic compounds for specific electrolyte additives and anodic materials. Various anode materials also have large differences in onset potential of oxygen evolution reaction (OER) and high OER electrodes are associated with poor mineralisation efficiency. There is also the cost of electricity consumption.

While there are AOPs known to degrade contaminants including organic contaminants in water, they are generally limited in applicability to degradation of particular substances, offer limited efficiency, require large energy input and are associated with high cost.

It would be beneficial to provide alternative materials that are able to be used in water treatment processes that may improve on one or more of the limitations of the described known processes, or at least to offer another choice.

### SUMMARY

In an aspect, the present disclosure relates to a solid oxidizable composition comprising manganese or an oxide thereof, iron or a cationic species thereof, and an oxidizable metal, wherein the manganese or oxide thereof is present in the composition in an amount of from about 65 wt % to about 95 wt %.

In some embodiments, the manganese or oxide thereof is present in the solid oxidizable composition in an amount of from about 70 wt % to about 95 wt %, preferably about 75 wt % to about 85 wt %.

In some embodiments, the iron or cationic species thereof is present in the solid oxidizable composition in an amount of from about 0.1 wt % to about 10 wt %, preferably about 0.5 wt % to about 5 wt %, more preferably about 1 wt % to about 2 wt %.

In some embodiments, the solid oxidizable composition comprises an oxide of manganese, preferably wherein the oxide of manganese is selected from one or more of the group consisting of manganese (II) oxide, manganese (III) oxide and manganese (IV) oxide, preferably wherein the oxide of manganese is manganese (IV) oxide.

In some embodiments, the solid oxidizable composition comprises a cationic iron species, preferably wherein the cationic iron species is an oxide of iron, preferably wherein the oxide of iron is selected from one or more of the group consisting of iron (II) oxide and iron (III) oxide, preferably iron (II) oxide.

In some embodiments, the oxidizable metal is selected from one or more of the group consisting of copper, lead, titanium, vanadium, aluminum, calcium, strontium, potassium, lithium, nickel, cobalt and cerium, preferably selected from one or more of the group consisting of copper, lead, titanium, lithium, nickel and cobalt, preferably selected from one or more of the group consisting of copper, lead and titanium, and is preferably copper.

In some embodiments, the oxidizable metal is selected from two, preferably three, or more of the group consisting of copper, lead, titanium, vanadium, aluminum, calcium, strontium, potassium, lithium, nickel, cobalt and cerium, preferably selected from two, preferably three, or more of the group consisting of copper, lead, titanium, lithium, nickel and cobalt, preferably selected from two, preferably all, of the group consisting of copper, lead and titanium.

In some embodiments, the oxidizable metal is present in the solid oxidizable composition in an amount of from about 0.001 wt % to about 10 wt %, preferably about 0.005 wt % to about 5 wt %, more preferably about 0.01 wt % to about 3 wt %.

In some embodiments, the solid oxidizable composition further comprises a cationic metal species, preferably wherein the cationic metal species comprises cations selected from one or more of the group consisting of copper, lead, titanium, vanadium, aluminum, calcium, strontium, potassium, lithium, nickel, cobalt and cerium, preferably selected from one or more of the group consisting of copper, lead, titanium, lithium, nickel and cobalt, preferably selected from one or more of the group consisting of copper, lead and titanium, and preferably copper.

In some embodiments, the cationic metal species is present in the solid oxidizable composition in an amount of from about 0.001 wt % to about 10 wt %, preferably about 0.005 wt % to about 5 wt %, more preferably about 0.01 wt % to about 3 wt %.

In some embodiments, the solid oxidizable composition is in the form of powder.

In another aspect, the present disclosure relates to a solid composition comprising an oxide of manganese, a cationic iron species, and a cationic metal species, wherein the oxide of manganese is present in the composition in an amount of from about 65 wt % to about 95 wt %.

In some embodiments, the oxide of manganese is present in the solid composition in an amount of from about 70 wt % to about 95 wt %, preferably about 75 wt % to about 85 wt %.

In some embodiments, the oxide of manganese is selected from one or more of the group consisting of manganese (II) oxide, manganese (III) oxide and manganese (IV) oxide, preferably wherein the oxide of manganese is manganese (IV) oxide.

In some embodiments, the cationic iron species is an oxide of iron, preferably wherein the oxide of iron is selected from one or more of the group consisting of iron (II) oxide and iron (III) oxide, preferably iron (III) oxide.

In some embodiments, the cationic iron is present in the solid composition in an amount of from about 0.1 wt % to about 10 wt %, preferably about 0.5 wt % to about 5 wt %, more preferably about 1 wt % to about 2 wt %.

In some embodiments, the cationic metal species comprises cations selected from one or more of the group consisting of copper, lead, titanium, vanadium, aluminum, calcium, strontium, potassium, lithium, nickel, cobalt and cerium, preferably selected from one or more of the group consisting of copper, lead, titanium, lithium, nickel and cobalt, preferably selected from one or more of the group consisting of copper, lead and titanium, and is preferably copper.

In some embodiments, the cationic metal species comprises cations selected from two, preferably three, or more of the group consisting of copper, lead, titanium, vanadium, aluminum, calcium, strontium, potassium, lithium, nickel, cobalt and cerium, preferably selected from two, preferably three, or more of the group consisting of copper, lead, titanium, lithium, nickel and cobalt, preferably selected from two, preferably all, of the group consisting of copper, lead and titanium.

In some embodiments, the cationic metal is present in the solid composition in an amount of from about 0.001 wt % to about 10 wt %, preferably about 0.005 wt % to about 5 wt %, more preferably about 0.01 wt % to about 3 wt %.

In some embodiments, the solid composition comprises cationic copper, lead, titanium, vanadium, aluminum, calcium, strontium, and potassium.

In some embodiments, the:
oxide of manganese is present in the solid composition in an amount of from about 70 wt % to about 95 wt %, preferably about 75 wt % to about 85 wt %;
cationic iron is present in the composition in an amount of from about 0.1 wt % to about 10 wt %, preferably about 0.5 wt % to about 5 wt %, more preferably about 1 wt % to about 2 wt %;
cationic copper is present in the solid composition in an amount of from about 0.01 wt % to about 10 wt %, preferably about 0.05 wt % to about 5 wt %, more preferably about 0.1 wt % to about 2 wt %;
cationic lead, titanium, vanadium, and strontium are each present in the solid composition in an amount of from about 0.001 wt % to about 1 wt %, preferably about 0.005 wt % to about 0.5 wt %, more preferably about 0.01 wt % to about 0.1 wt %; and
cationic aluminum, calcium and potassium are each present in the solid composition in an amount of from about 0.01 wt % to about 5 wt %, preferably about 0.05 wt % to about 2 wt %, more preferably about 0.1 wt % to about 1 wt %.

In some embodiments, the solid composition is in the form of granules.

In some embodiments, the granules are characterizable by a particle size diameter in the range of about 0.01 mm to about 2 mm, preferably about 0.05 mm to about 1 mm, preferably about 0.2 mm to about 0.5 mm.

In some embodiments, the solid composition is porous.

In some embodiments, the solid composition is characterizable by a BET surface area in the range of about 10 m²/g to about 25 m²/g, preferably about 15 m²/g to about 25 m²/g, preferably about 20 m²/g to about 25 m²/g.

In another aspect, the present disclosure relates to a process for producing a solid composition as herein described, comprising subjecting a solid oxidizable composition as herein described to oxidizing conditions.

In some embodiments, the process comprises the preliminary steps of:
a) providing a mixed solid oxidizable composition as herein described, optionally wherein one or more of the manganese or an oxide thereof, iron or cationic species thereof, and oxidizable metal are in powder form;
b) optionally sintering the mixed solid oxidizable composition; and
c) optionally sizing the mixed solid oxidizable composition.

In some embodiments, each of the manganese or an oxide thereof, iron or cationic species thereof, and oxidizable metal are in powder form.

In some embodiments, step c) is performed and the mixed solid oxidizable composition is sized into granules.

In some embodiments, the oxidizing conditions comprise contacting the solid oxidizable composition with an oxidant, preferably wherein the oxidant is selected from one or more of the group consisting of hypochlorite, chlorine dioxide and ozone.

In another aspect, the present disclosure relates to a solid composition produced by a process as herein described.

In another aspect, the present disclosure relates to a method for treating water containing contaminants, comprising contacting contaminated water with a solid composition as herein described.

In another aspect, the present disclosure relates to a kit for forming a solid oxidized composition as herein described, the kit comprising a solid oxidizable composition as herein described or the separate components thereof, and an oxidant, together with instructions for forming a solid composition as herein described from the solid oxidizable composition or the separate components thereof, and the oxidant.

### DETAILED DESCRIPTION

Unless otherwise defined, all technical and scientific terms used herein have the same meaning as commonly understood by those of ordinary skill in the field of the present disclosure. Although any methods and materials similar or equivalent to those described herein can be used in the practice or testing of the present disclosure, preferred methods and materials are described. For the purposes of the present disclosure, a number of terms are defined herein.

The present disclosure refers to the entire contents of certain documents being incorporated herein by reference.

It is to be understood that if any prior art publication is referred to herein, such reference does not constitute an admission that the publication forms a part of the common general knowledge in the art.

As used herein, the term “and/or”, e.g., “X and/or Y” shall be understood to mean either “X and Y” or “X or Y” and shall be taken to provide explicit support for both meanings or for either meaning.

The term “about” as used herein, when referring to a numerical value or range, allows for a degree of variability in the value or range, for example within 10% of a stated limit of a range.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Throughout this specification, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the word “comprise” and other forms of the word, such as “comprising” and “comprises,” means including but not limited to, and is not intended to exclude, for example, other additives, components, integers, or steps.

### Solid Oxidizable Composition

Disclosed herein is a solid oxidizable composition comprising manganese or an oxide thereof, iron or a cationic species thereof, and an oxidizable metal, wherein the manganese or oxide thereof is present in the composition in an amount of from about 65 wt % to about 95 wt %.

The term “oxidizable composition” refers to the composition as described herein and is used simply as a label to differentiate the composition from a solid composition simpliciter as also described herein.

The term “[metal]” simpliciter when used in the context of a material and without a qualifying term as to charge or oxidation state refers to a metal in its zero-oxidation state. For example, the material “manganese” sans e.g., “cationic” means manganese metal in its zero-oxidation state, i.e., Mn⁰. Similarly, the material “iron” simpliciter means iron metal in its zero-oxidation state, i.e., Fe⁰.

Herein, a metal may generically be denoted as “[M]”.

The manganese or oxide thereof is present in the solid oxidizable composition in an amount of from about 65 wt % to about 95 wt %, which may be any of about 65, 66, 67, 68, 69, 70, 71, 72, 73, 74, 75, 76, 77, 78, 79, 80, 81, 82, 83, 84, 85, 86, 87, 88, 89, 90, 91, 92, 93, 94 or 95 wt %. In preferred embodiments, the manganese or oxide thereof is present in the solid oxidizable composition in an amount of from about 70 wt % to about 95 wt %, which may be any of about 70, 71, 72, 73, 74, 75, 76, 77, 78, 79, 80, 81, 82, 83, 84, 85, 86, 87, 88, 89, 90, 91, 92, 93, 94 or 95 wt %. Preferably, the manganese or oxide thereof is present in the solid oxidizable composition in an amount of from about 75 wt % to about 85 wt %, which may be any of 75, 76, 77, 78, 79, 80, 81, 82, 83, 84 and 85 wt %.

Herein, oxides of manganese, and especially the preferred oxides of manganese, may generally be considered to be cationic manganese species.

The term “species” in the context of a material is meant that the material contains the specified integer in a form which renders it available to participate in chemical interactions external to that species.

The term “cationic” refers to a positive oxidation state.

Thus, a “cationic manganese species” refers to a material, generally a molecule, which contains cationic manganese and renders the cationic manganese (e.g., as Mn³⁺)—that is, manganese in a positive oxidation state—available, for example in aqueous environments, to participate in chemical interactions external to that material.

Oxides of manganese are known or identifiable to one of skill in the art. Examples include manganese (II) oxide (MnO), manganese (II,III) oxide (Mn₃O₄), manganese (III) oxide (Mn₂O₃), manganese (IV) dioxide (MnO₂), manganese (VI) oxide (MnO₃) and manganese (VII) oxide (Mn₂O₇).

The terms (I), “(II)”, “(III)” etc. refer to a positive oxidation state of an atom in a molecule. A positive oxidation state represents a loss of electrons of an atom in a molecule and is an indicator of charge if the atom were to exist as a free ion. For instance, the free ion of the manganese (II) atom in MnO may be represented as Mn²⁺, while the free ion of the manganese (III) atom in Mn₂O₃ may be represented as Mn³⁺. An atom with a positive oxidation state may also be referred to as “cationic”, which indicates a net positive charge.

In preferred embodiments, the solid oxidizable composition comprises an oxide of manganese. In preferred embodiments, the oxide of manganese is an inorganic material (e.g., at the exclusion of organometallic materials). Preferably the oxide of manganese comprises manganese having an oxidation state of (II) or higher, e.g., (II), (III) and/or (IV). In more preferred embodiments, the oxide of manganese comprises manganese having an oxidation state of (IV). In most preferred embodiments, the oxide of manganese is manganese (IV) dioxide (MnO₂) (otherwise referred to herein as “manganese dioxide” or MnO₂).

Similarly, a “cationic species of iron” (also referred to as a “cationic iron species”) refers to a material, generally a molecule, which contains cationic iron and renders the cationic iron (e.g., as Fe²⁺ or Fe³⁺)—that is, iron in a positive oxidation state—available, for example in aqueous environments, to participate in chemical interactions external to that material.

Many cationic iron species are known or identifiable to a person skilled in the art. Examples include iron (II) oxide (FeO), iron (III) oxide (Fe₂O₃), iron (II,III) oxide (Fe₃O₄), iron (II) sulfate (FeSO₄), iron (III) sulfate (Fe₂(SO₄)₃), iron (II) chloride (FeCl₂), iron (III) chloride (FeCl₃), iron (II) nitrate (Fe(NO₃)₂), iron (III) nitrate (Fe(NO₃)₃, ammonium iron (II) sulfate (NH₄Fe(SO₄)₂), iron (II) phosphate (Fe₃(PO₄)₂), iron (III) phosphate (FePO₄), iron (II) sulfide (FeS) and iron (III) sulfide (Fe₂S₃).

In preferred embodiments, the solid oxidizable composition comprises a cationic iron species. In preferred embodiments, the cationic iron species is an inorganic material (e.g., at the exclusion of organometallic materials). In preferred embodiments, the cationic iron species contains iron (II) (i.e., Fe²⁺) and/or iron (III) (i.e., Fe³⁺), preferably iron (II). Iron (II) and iron (III) species may be referred to as “ferrous” and “ferric”, respectively. Preferably, the cationic iron species is an oxide of iron, preferably wherein the oxide of iron is selected from one or more of the group consisting of iron (II) oxide and iron (III) oxide, preferably iron (II) oxide (FeO).

In preferred embodiments, the iron or cationic species thereof is present in the solid oxidizable composition in an amount of from about 0.1 wt % to about 10 wt %, preferably about 0.5 wt % to about 5 wt %, more preferably about 1 wt % to about 2 wt %.

The term “oxidizable metal” refers to a metal which, under typical atmospheric pressure and temperature conditions, is capable of existing in a zero-oxidation state and also in a positive oxidation state, i.e., (I), (II), (III) or higher. The solid oxidizable composition described herein thus may thus comprise [M]⁰.

The oxidizable metal may be an alkali metal, an alkali earth metal, a transition metal, a lanthanide and/or an actinide. In preferred embodiments, the oxidizable metal is an alkali metal, an alkali earth metal and/or a transition metal, and preferably a transition metal.

In preferred embodiments, the oxidizable metal is capable of existing in two different positive oxidation states, e.g., (I) and (II) or (III) and (IV). Most transition metals meet this description.

In preferred embodiments, the oxidizable metal has an electrical conductivity greater than that of manganese. Electrical conductivity refers to the ability of a material to conduct electric current, and is a known concept in the art. The electrical conductivity of many metals is known in the art. International standard methods for measuring electrical conductivity of a material are also known in the art. The electrical conductivity of manganese is about 6.94×10⁵ S/m. Examples of metals which have a greater electrical conductivity than manganese include silver, copper, gold, aluminum, calcium, rhodium, tungsten, zinc, cobalt, nickel, ruthenium, lithium, iron, platinum, tin, gallium, lead, titanium and mercury.

In some embodiments, the oxidizable metal is selected from one or more of the group consisting of copper, lead, titanium, vanadium, aluminum, calcium, strontium, potassium, lithium, nickel, cobalt and cerium. Preferably, the oxidizable metal is selected from one or more of the group consisting of copper, lead, titanium, lithium, nickel and cobalt, more preferably selected from one or more of the group consisting of copper, lead and titanium, and is most preferably copper.

In preferred embodiments, the solid oxidizable composition comprises two, preferably three, or more oxidizable metals. Preferably, the oxidizable metal is selected from two, preferably three, or more of the group consisting of copper, lead, titanium, vanadium, aluminum, calcium, strontium, potassium, lithium, nickel, cobalt and cerium, preferably selected from two, preferably three, or more of the group consisting of copper, lead, titanium, lithium, nickel and cobalt. In most preferred embodiments the oxidizable metals is selected from two, preferably all, of the group consisting of copper, lead and titanium.

In preferred embodiments, the solid oxidizable composition further comprises a cationic metal species.

A “cationic metal species” refers to a material, generally a molecule, which contains cationic metal and renders the cationic metal (e.g., as [M]⁺)—that is, a metal in a positive oxidation state—available, for example in aqueous environments, to participate in chemical interactions external to that material—with one proviso: when a cationic manganese species and/or a cationic iron species are present, then a cationic metal species is taken to be a species of a cationic metal that is other than manganese and iron. In other words, in preferred embodiments the cationic metal species provides a cationic metal that is other than manganese and iron.

The cationic metal species may comprise a cationic metal which is an alkali metal, an alkali earth metal, a transition metal, a lanthanide and/or an actinide. In preferred embodiments, the cationic metal species contains an alkali metal, an alkali earth metal and/or a transition metal, and preferably a transition metal.

In preferred embodiments, the cationic metal species comprises a cationic metal that is capable of existing in two different positive oxidation states, e.g., (I) and (II) or (III) and (IV). Most transition metals meet this description.

In preferred embodiments, the cationic iron species is an inorganic material (e.g., at the exclusion of organometallic materials). Preferably, the cationic metal species comprises cations selected from one or more of the group consisting of copper, lead, titanium, vanadium, aluminum, calcium, strontium, potassium, lithium, nickel, cobalt and cerium, preferably selected from one or more of the group consisting of copper, lead, titanium, lithium, nickel and cobalt, preferably selected from one or more of the group consisting of copper, lead and titanium, and preferably copper.

In preferred embodiments, the cationic metal species is a metal oxide.

In preferred embodiments, the cationic metal species is present in the solid oxidizable composition in an amount of from about 0.001 wt % to about 10 wt %, preferably about 0.005 wt % to about 5 wt %, more preferably about 0.01 wt % to about 3 wt %.

In preferred embodiments, the solid oxidizable composition is in the form of a homogeneous mixture. In other words, given that the manganese or oxide thereof is present in the greatest amount, it is preferred that the iron or cationic species thereof, and the oxidizable metal, are evenly dispersed in the manganese or oxide thereof.

Preferably, the manganese or an oxide thereof, iron or cationic species thereof, oxidizable metal and any other components are present in powder form for reasons described below.

Applicants have found that a solid oxidizable composition as described herein is particularly useful for the formation of a solid composition as described herein, especially by the process as described herein.

### Solid Composition

Disclosed herein is a solid composition comprising an oxide of manganese, a cationic iron species, and a cationic metal species, wherein the oxide of manganese is present in the composition in an amount of from about 65 wt % to about 95 wt %.

The term “composition” simpliciter without a qualifier (e.g., oxidizable) refers to the composition as described herein and is used simply as a label to differentiate the composition form an oxidizable composition as also described herein.

Oxides of manganese are as described above.

In preferred embodiments, the oxide of manganese comprises manganese having an oxidation state of (III) or higher, e.g., (III) and/or (IV). In more preferred embodiments the oxide of manganese comprises manganese having an oxidation state of (IV). In most preferred embodiments, the oxide of manganese is manganese (IV) dioxide.

The oxide manganese is present in the composition in an amount of from about 65 wt % to about 95 wt %, which may be any of about 65, 66, 67, 68, 69, 70, 71, 72, 73, 74, 75, 76, 77, 78, 79, 80, 81, 82, 83, 84, 85, 86, 87, 88, 89, 90, 91, 92, 93, 94 or 95 wt %. In preferred embodiments, the oxide of manganese is present in the composition in an amount of from about 70 wt % to about 95 wt %, which may be any of about 70, 71, 72, 73, 74, 75, 76, 77, 78, 79, 80, 81, 82, 83, 84, 85, 86, 87, 88, 89, 90, 91, 92, 93, 94 or 95 wt %. Preferably, the oxide of manganese is present in the composition in an amount of from about 75 wt % to about 85 wt %, which may be any of 75, 76, 77, 78, 79, 80, 81, 82, 83, 84 and 85 wt %.

Cationic iron species are as described above.

In preferred embodiments, the cationic iron species is an inorganic material (e.g., at the exclusion of organometallic materials). In preferred embodiments, the cationic iron species is an iron oxide, preferably iron (II) oxide (FeO), iron (III) oxide (Fe₂O₃) and/or iron (II,III) oxide (Fe₃O₄), most preferably iron (III) oxide.

In preferred embodiments, the cationic iron is present in the solid composition in an amount of from about 0.1 wt % to about 10 wt %, preferably about 0.5 wt % to about 5 wt %, more preferably about 1 wt % to about 2 wt %.

Cationic metal species are as described above.

In preferred embodiments, the cationic iron species is an inorganic material (e.g., at the exclusion of organometallic materials). Preferably, the cationic metal species comprises a cationic metal selected from one or more of the group consisting of copper, lead, titanium, vanadium, aluminum, calcium, strontium, potassium, lithium, nickel, cobalt and cerium. Preferably, the cationic metal species comprises a cationic metal selected from one or more of the group consisting of copper, lead, titanium, lithium, nickel and cobalt, more preferably selected from one or more of the group consisting of copper, lead and titanium, and most preferably copper.

In preferred embodiments, the cationic metal species comprises two, preferably three, or more cationic metals. This may be by way of one or two or more molecules, two of which comprising a different cationic metal. Preferably, the cationic metal species comprises two, preferably three, or more cationic metals selected from the group consisting of copper, lead, titanium, vanadium, aluminum, calcium, strontium, potassium, lithium, nickel, cobalt and cerium, preferably selected from two, preferably three, or more of the group consisting of copper, lead, titanium, lithium, nickel and cobalt. In most preferred embodiments the cationic metal species comprises two, preferably all, of the cationic metals selected from copper, lead and titanium.

In preferred embodiments, along with an oxide of manganese, and a cationic iron species, the solid composition comprises copper, lead and titanium, at least one of which may constitute the cationic metal of the cationic metal species. More preferably, along with an oxide of manganese, and a cationic iron species, the solid composition comprises copper, lead, titanium, vanadium, aluminum, calcium, strontium, and potassium, at least one of which may constitute the cationic metal of the cationic metal species.

In preferred embodiments, the cationic metal species is a metal oxide.

In preferred embodiments, the cationic metal is present in the solid composition in an amount of from about 0.001 wt % to about 10 wt %, preferably about 0.005 wt % to about 5 wt %, more preferably about 0.01 wt % to about 3 wt %.

For water treatment applications, it is preferred that the cationic metal species contains a cationic metal that is generally regarded to be non-toxic, or that the cationic metal species is used in amounts that are generally regarded to be safe. It is also preferred that the other components of the solid composition are non-toxic or used in amounts that are generally regarded to be safe.

In preferred embodiments, the cationic metal species is an inorganic material (e.g., at the exclusion of organometallic materials).

In preferred embodiments, along with an oxide of manganese and a cationic iron species the solid composition comprises a cationic metal species wherein the cationic metal is each of copper, lead and titanium. More preferably, along with an oxide of manganese and a cationic iron species the solid composition comprises a cationic metal species wherein the cationic metal is each of copper, lead, titanium, vanadium, aluminum, calcium, strontium, and potassium. In these embodiments, preferably the:
oxide of manganese is present in the solid composition in an amount of from about 70 wt % to about 95 wt %, preferably about 75 wt % to about 85 wt %;
cationic iron is present in the composition in an amount of from about 0.1 wt % to about 10 wt %, preferably about 0.5 wt % to about 5 wt %, more preferably about 1 wt % to about 2 wt %;
cationic copper is present in the solid composition in an amount of from about 0.01 wt % to about 10 wt %, preferably about 0.05 wt % to about 5 wt %, more preferably about 0.1 wt % to about 2 wt %;
cationic lead, titanium, vanadium, and strontium are each present in the solid composition in an amount of from about 0.001 wt % to about 1 wt %, preferably about 0.005 wt % to about 0.5 wt %, more preferably about 0.01 wt % to about 0.1 wt %; and
cationic aluminum, calcium and potassium are each present in the solid composition in an amount of from about 0.01 wt % to about 5 wt %, preferably about 0.05 wt % to about 2 wt %, more preferably about 0.1 wt % to about 1 wt %.

Other components may be present in minor amounts. For example, silica may often be present, for example in an amount of about 5 wt % or less.

The solid composition may be in particulate or monolithic form. In preferred embodiments, the solid composition is in particulate form, more preferably in the form of granules. More preferably, the solid composition is in particulate form which is characterizable by a particle size diameter in the range of about 0.01 mm to about 2 mm, preferably about 0.05 mm to about 1 mm, preferably about 0.2 mm to about 0.5 mm. By “diameter” does not limit the shape of a particle and refers to the greatest axial dimension. Methods for determining particle size are known in the art and include physical methods such as sorting or sieving, and also include small angle X-ray scattering, dynamic light scattering and transmission electron microscopy.

In preferred embodiments, the solid composition is porous. A solid composition that is porous is one which contains pores. A “pore” is a space which is devoid of the solid material that makes up the composition. Pores may be considered hierarchically in terms of pore size, as micropores, mesopores and macropores. A “micropore” refers to a pore with a diameter of less than 2 nm. A “mesopore” refers to a pore with a diameter of from 2 nm to 50 nm. A “macropore” refers to a pore with a diameter of from 50 nm to 100 micrometres. By “diameter” does not limit the shape of a pore and refers to the greatest axial dimension. In preferred embodiments, the solid composition is mesoporous, meaning containing mesopores. Preferably, the average pore size is in the range of from about 2 nm to about 15 nm, preferably about 4 nm to about 10 nm, and preferably about 7 nm to about 8 nm. Pore size is experimentally determinable using methods known in the art. Known methods include gas adsorption (including using a BET surface analyser), scanning electron microscopy and liquid intrusion (including mercury porosimetry). Preferably, a BET surface analysis is used for measuring pore sizes.

In preferred embodiments, the particulate form is characterizable by a specific surface area of about 10 m²/g to about 25 m²/g, preferably about 15 m²/g to about 25 m²/g, preferably about 20 m²/g to about 25 m²/g. Specific surface area is experimentally determinable using methods known in the art including gas adsorption (including using a BET surface analyser) and liquid intrusion (including mercury porosimetry). Preferably, a BET surface analysis is used.

In preferred embodiments, the solid composition is in the form of a homogeneous mixture. In other words, given that the oxide of manganese is present in the greatest amount, it is preferred that the cationic iron species and the cationic metal species (and any other components present) are evenly dispersed in the oxide of manganese. This has the advantage of reducing function losses of the solid composition as compared with, for example, coated compositions which may lose function in use from mechanical abrasion.

Applicants have found that a solid composition as described herein are particularly useful in water treatment applications, and especially in the treatment of water containing organic contaminants, to reduce the amount of contamination of the water. This includes organic contaminants of pharmaceutical, household chemical and personal care compounds, herbicides, pesticides, microplastics and blue-green algae toxins.

Applicants have found that the solid compositions are capable of acting as catalysts in CAO processes and also, surprisingly, in electrochemical oxidation processes without an input current, including simultaneously. Oxides of manganese which are cationic manganese species, a cationic iron species, and a cationic metal species, are all capable of making available in aqueous environments cations of their respective metals which are capable of participating in CAO processes and also, simultaneously, electrochemical oxidation processes.

Without wishing to be limited by theory, it is believed that the combination of components in the solid composition are together capable of acting as a cathode in electrochemical oxidation processes in a similar fashion to the cathode of an alkaline battery. It is believed that the manganese dioxide is capable of acting as a cathode and also that one or both of the cationic iron species and cationic metal species are capable of acting as a cathode in this way. It has been found that an input current is not needed to cause electrochemical oxidation as in traditional electrochemical oxidation processes; rather it is believed that electrical charge and discharge occurs simultaneously at a large number of sites within the material simultaneously, the mobility and exchange of electrons producing electrochemical oxidation reactions with contaminants, especially organic contaminants, independently.

It is believed that the CAO process of the catalyst functions through reactions involving the catalyst splitting a water molecule (i.e., H₂O→H⁺+OH⁻) and then oxidizing the hydroxyl ion to a hydroxyl radical which degrades contaminants, especially organic contaminants. It is believed that the electrochemical process of the catalyst functions through reactions involving an electrochemical reduction of cationic manganese to produce hydroxyl radicals which degrades contaminants.

Applicants have found that a catalyst which comprises an oxide of manganese (cationic manganese species) in the specified proportion along with a cationic iron species, and a cationic metal species, is capable of reducing a greater amount of contamination in water than a catalyst containing only one of said species, in terms of both an absolute amount, in terms of a broader range of contaminant molecules, and in less time. In particular, Applicants have found that a solid composition as described herein when used as a water treatment catalyst is capable of decreasing the amount of organic contaminants equivalent to other methods in around a third of the time, up to a small fraction of the time including as low as a one hundredth of the time.

The preferred porous composition, and also the preferred granular form of the composition, especially when coupled together, are beneficial for increasing the specific surface area of the composition which in turn increases the sites at which degradation of contaminant compounds can occur and increases the CAO and electrochemical oxidation capabilities of the material.

In addition to degradation of particularly organic contaminant molecules, other beneficial capabilities of a solid composition as described herein are as follows:
Reduction of colour from water caused by natural organic matter;
Decomposition and reduction of organic matter containing nitrogen and ammoniacal nitrogen with release of nitrogen gas;
Reduction of inorganic contaminants such as heavy metals through precipitation and co-precipitation;
Reduction of phosphate through both catalytic oxidation and absorption;
Quenching of dissolved ozone and hydrogen peroxide (which may be present in water from other treatment processes); and
Reduction of pathogen content.

Another benefit of the solid compositions as described herein is the ability for it to be regenerated. During water treatment the oxide of manganese, cationic iron species and cationic metal species are consumed in the reduction of contaminants by way of the positive oxidized state of the cations being reduced. The solid composition is regenerable by subjecting to oxidizing conditions, preferably by way of contacting it with an oxidant. The oxidant may be selected from one or more of oxygen, permanganate, ozone, hydrogen peroxide and hypochlorite. Applicants have found that all three of the oxide of manganese, cationic iron species and cationic metal species, especially in the preferred embodiments, are regenerable in this way, including simultaneously.

A benefit of the use of a cationic iron species is not only its ability to participate in CAO and electrochemical oxidation processes as part of a solid composition, but also that in water treatment applications, iron is generally regarded to be non-toxic. The same benefit applies to copper when copper is included in the solid composition, including as a preferred cationic metal species.

There is also a benefit of the particulate form of the solid composition. Applicants have found that granules in the preferred size range and/or which are porous and characterizable by the preferred BET surface area are particularly suitable for degrading contaminant molecules, it is believed by increasing the number of sites of the material at which degradation reactions can occur.

Another benefit of the particulate form of the solid composition is that it is capable of acting as a physical filter to remove solid materials from a water stream passing through a bed of the solid composition.

Applicants have also found that a solid composition as described herein is resistant to corrosion by hydrogen peroxide in water, including in amounts of up to 1,000 mg/L. This contrasts with traditional CAO catalysts which are susceptible to corrosion by hydrogen peroxide even at low amounts.

### Production Processes

Disclosed herein is a process for producing a solid composition as described herein, comprising subjecting a solid oxidizable composition as described herein to oxidizing conditions.

The term “oxidizing conditions” is meant chemical conditions capable of converting a metal or metal species in a zero or positive oxidation state into a metal species in a higher positive oxidation state, e.g., Mn⁰ to Mn⁴⁺ or Fe²⁺ to Fe³⁺ by chemical reaction.

A particular benefit of the solid oxidizable composition as described is its capability, especially comprising the preferred components, of being converted into a solid composition from a single oxidizable composition, using one or more steps of subjecting the solid oxidizable composition to oxidizing conditions. Further, Applicants have found that the conversion of manganese or an oxide thereof, iron or a cationic species thereof and oxidizable metals, to species with a higher oxidation state, is achievable simultaneously in a single reaction step, especially when the species concerned are metal oxides.

This, coupled with the water treatment capability of manganese dioxide, is why it is preferred that the cationic iron species is an oxide, and why it is preferred that the cationic metal species is an oxide. The solid oxidizable composition may be converted to a solid composition as described herein containing metal oxides, in a single step using oxidizing conditions.

Oxidizing conditions are known or determinable to those of skill in the art. In preferred embodiments, in the case of converting metal to metal oxides, this involves contacting the solid oxidizable composition with an oxidant. The preferred oxidants are selected from one or more of the group consisting of hypochlorite, chlorine dioxide and ozone.

After the step of subjecting a solid oxidizable composition as described herein to oxidizing conditions, the step of washing the formed solid composition may be performed. Water is suitable for washing, including tap water. The washed solid oxidizable composition may then be dried.

In preferred embodiments, the process comprises the following preliminary steps:
a) providing a mixed solid oxidizable composition as described herein, optionally wherein one or more of the manganese or an oxide thereof, iron or cationic species thereof, and oxidizable metal are in powder form;
b) optionally sintering the mixed solid oxidizable composition to produce a sintered solid oxidizable composition; and
c) optionally sizing the mixed solid oxidizable composition and/or the sintered solid oxidizable composition.

Preferably, the manganese or an oxide thereof, iron or cationic species thereof, and oxidizable metal are in powder form. This has advantage in assisting to form a homogeneous mixture. Preferably, the mixed solid oxidizable composition is sintered. Preferably, the sintered solid oxidizable composition is sized.

Methods for sintering and sizing are known or determinable to those of skill in the art. The sizing may be to increase or decrease particle size. Given that it is preferred that the manganese or an oxide thereof, iron or cationic species thereof, and oxidizable metal of the solid oxidizable composition are in powder form, and preferred that the solid oxidized composition is in the form of granules, it is preferred that the sizing is to increase particle size relative thereto.

For this reason, another preliminary step is available and preferred, being to form the mixed solid oxidizable composition or the sintered solid oxidizable composition into blocks. Methods for forming blocks are known and determinable to those in the art, and generally involve compaction. A wax lubricant may optionally be used to assist compaction (and release of the material from dies). The sizing may then be performed using the known processes of crushing and sieving. Preferably the solid oxidizable composition is formed into blocks prior to sintering, and the sintered solid oxidizable composition is sized.

Copper is a particularly preferred oxidizable metal in the solid oxidizable composition because, as Applicants have found, copper acts as a binder of the composition including through a sintering process.

### Water Treatment

Disclosed herein is a method for treating water containing contaminants, comprising contacting contaminated water with a solid composition as described herein.

The method is particularly useful for treating water containing organic contaminants.

In a general process, a solid composition as described herein is loaded to a water treatment vessel and water to be treated is passed through the solid composition.

A number of water pre-treatment steps are available alone or in combination, including a clarification or filtration step and a step of dosing with an oxidant, for example ozone, hydrogen peroxide, chlorine dioxide, permanganate or hypochlorite.

In preferred embodiments, the water to be treated is pre-treated by an initial clarification step

Also preferred is that the water is pre-treated by a step of dosing it with an oxidant, preferably ozone. Applicants have found that this assists to break-up organic contaminants into charged molecules which improves the water treatment process by causing the charged molecules to be attracted to the reactive sites of the catalytic material. It also assists the degradation by oxidising hydroxyl ions to hydroxyl radicals. It also assists to maintain the water oxidation-reduction potential (ORP) above +400 mV which assists the electrochemical oxidation process for the degradation of contaminants, especially organic contaminants.

If hydrogen peroxide is used, a step of quenching hydrogen peroxide is generally not required, as Applicants have found that the catalytic material itself is capable of quenching hydrogen peroxide.

Coincidental treatment steps are also applicable. In preferred embodiments the aqueous environment of the catalyst is maintained with a pH of 6 or higher. As the splitting of water molecules and consumption of hydroxyl ions creates free hydrogen ions, the pH of the aqueous environment may fall. In one coincidental treatment step, the water to be treated may be dosed with an alkaline material, such as sodium hydroxide.

Water treatment vessels and other apparatus for performing the pre-treatment steps are known or determinable to those of skill in the art.

### Kits

Also disclosed herein is a kit for forming a solid oxidized composition as herein described, the kit comprising a solid oxidizable composition as herein described or the separate components thereof, and an oxidant, together with instructions for forming a solid composition as herein described from the solid oxidizable composition or the separate components thereof, and the oxidant.

Reference will now be made in detail to exemplary embodiments of the disclosure. While the disclosure will be described in conjunction with the exemplary embodiments, it will be understood that it is not intended to limit the disclosure to those embodiments. To the contrary, it is intended to cover alternatives, modifications, and equivalents as may be included within the spirit and scope of the disclosure as defined by the appended claims.

### EXAMPLES

### Example 1

### Process for Producing a Solid Composition

A mixture of powders of metals and metal oxides is provided by mixing in the desired proportion to provide a solid oxidizable composition. The mixture is pressed into solid blocks, sintered, crushed and sieved for granular size grading. The granular material is subjected to oxidation for formation of metal oxides by contacting it with the oxidant sodium hypochlorite, chlorine dioxide or ozone. The material is then washed with tap water, dried and is ready to be used for treatment of water.

The composition of solid oxidizable composition as determined using X-ray fluorescence spectroscopy is shown in Table 1.

TABLE 1
Solid oxidizable composition.

| Component | Amount | |
|---|---|---|
| Manganese dioxide | 75-85 | wt % |
| Iron | 1.8 | wt % |
| Copper | 0.4-1.3 | wt % |
| Lead | 500 | ppm |
| Titanium | 400 | ppm |
| Vanadium | 200 | ppm |
| Aluminium | 6500 | ppm |
| Calcium | 1100 | ppm |
| Strontium | 100 | ppm |
| Sulphur | 4000-5000 | ppm |
| Potassium | 1800 | ppm |
| Phosphorous | 500 | ppm |

| | |
|---|---|
| Silica | 1.8 |

### Example 2

### Method for Treating Water

A water treatment vessel is loaded with a bed of supporting material being large granular size silica (2 to 5 mm size) or garnet. A bed of granular material of Example 1 is added.

Water to be treated is dosed with an oxidant selected from one or more of sodium hypochlorite, chlorine dioxide, potassium permanganate, hydrogen peroxide and ozone. The dosed water is then passed through the water treatment vessel (O₃-MQX)

Further exemplification of water treatment processes is contained in Applicants related application filed on the same date and entitled “Process and Apparatus for Water Treatment”, which is hereby incorporated by reference in its entirety.

### Example 3

### Method for Treating Surface Water

The treatment method of Example 2 was compared side-by side with a system which clarifies the water to be treated followed by ozonation and biological activated carbon filtration (O₃-BAC).

Characteristics of the output water stream form the two treatment processes are provided in Table 2.

TABLE 2
Characteristics of water treated using O₃-BAC vs O₃-MQX.

| Characteristic | O₃-BAC | O₃-MQX |
|---|---|---|
| Turbity (NTU) | 0.24-0.35 | 0.01-0.13 |
| Colour [Hu] | 4-2.4 | 0 |
| Total organic carbon (TOC) | 4.72-5.79 | 3.36-3.94 |

O₃-MQX outperformed O₃-BAC across all three characteristics. On average the TOC was further decreased by 30% with O₃-MQX as compared to O₃-BAC. Turbidity and colour with O₃-MQX met the requirements of compliant, high quality water while turbidity and colour with O₃-BAC did not.

In similar experiments performed treating clarified water, using O₃-MQX the reduction in TOC was on average 2 to 2.5 times higher than O₃-BAC.

### Example 4

### Method for Treating Catchment Water for Domestic Supply

A water treatment vessel as per Example 2 and loaded with the catalyst of Example 1 (MQX) and using a pre-treatment clarification step was compared in side-by side experiments with three treatment vessels using, as a granular catalyst, a coated manganese dioxide (IWM), a composition containing 20% manganese and 26% iron as oxides (mainly manganese dioxide and ferric oxide) (AH), and a composition containing 50% manganese and 2.7% iron as oxides (mainly manganese dioxide and ferric oxide) (MQ).

The water to be treated was clarified and characterised by a dissolved organic carbon (DOC) content of up to about 10 mg/L and a colour of up to in excess of 45 HU.

Characteristics of the input water source and output water stream form the two treatment processes are provided in Table 3.

TABLE 3
Characteristics of water treated using IWM, AH, MQ vs MQX.

| Characteristic | Clarified water | IWM | AH | MQ | MQX |
|---|---|---|---|---|---|
| Colour (HU), 400 nm | 47 | 5 | 2 | 2 | <0.1 |
| Turbidity (mg/L) | 7.2 | 0.3 | <0.1 | 0.4 | <0.1 |
| TOC (mg-L | 14.2 | 5.8 | 4.4 | 4.6 | 1.6 |
| DOC (mg/L) | 14.2 | 5.6 | 4.4 | 4.3 | 1.5 |

MQX outperformed IWM across all four characteristics. It also outperformed AH for colour, TOC and DOC, and was equivalent for turbidity even though the catalyst contains significantly less iron cations (1.4% cf. 26%). MQX also outperformed MQ across all four characteristics including, attributed to the combination of the higher manganese dioxide content and presence of another cationic metal (in this case copper in the highest proportion).

These results show that the MQX catalyst having greater than 65% manganese dioxide, cationic iron even in a comparatively low amount, and another cationic metal (in this case, copper in the highest proportion) is significantly more capable of reducing the amount of TOC and TOC in water to be treated than its comparators.

The above examples are only the preferred examples of the present disclosure. It shall be pointed out that various improvements and modifications could be made by those ordinarily skilled in the art without deviating from the principle of the present disclosure, which shall fall within the protection scope of the present disclosure.

1. A solid oxidizable composition comprising manganese or an oxide thereof, iron or a cationic species thereof, and an oxidizable metal, wherein the manganese or oxide thereof is present in the composition in an amount of from about 65 wt % to about 95 wt %.

2. The solid oxidizable composition according to claim 1, wherein:
a) the manganese or oxide thereof is present in the composition in an amount of from about 70 wt % to about 95 wt %;
b) the iron or cationic species thereof is present in the composition in an amount of from about 0.1 wt % to about 10 wt %; and/or
c) the oxidizable metal is present in the composition in an amount of from about 0.001 wt % to about 10 wt %.

3. (canceled)

4. The solid oxidizable composition according to claim 1, wherein the solid oxidizable composition comprises an oxide of manganese.

5. The solid oxidizable composition according to claim 1, wherein the solid oxidizable composition comprises a cationic iron species.

6. The solid oxidizable composition according to claim 1, wherein the oxidizable metal is selected from one or more of the group consisting of copper, lead, titanium, vanadium, aluminum, calcium, strontium, potassium, lithium, nickel, cobalt and cerium.

7. The solid oxidizable composition according to claim 1, wherein the oxidizable metal is selected from two or more of the group consisting of copper, lead, titanium, vanadium, aluminum, calcium, strontium, potassium, lithium, nickel, cobalt and cerium.

8. (canceled)

9. The solid oxidizable composition according to claim 1, wherein the solid oxidizable composition further comprises a cationic metal species.

10. The solid oxidizable composition according to claim 9, wherein the cationic metal species is present in the solid oxidizable composition in an amount of from about 0.001 wt % to about 10 wt %.

11. (canceled)

12. A solid composition comprising an oxide of manganese, a cationic iron species, and a cationic metal species, wherein the oxide of manganese is present in the composition in an amount of from about 65 wt % to about 95 wt %.

13. The solid composition according to claim 12, wherein:
a) the oxide of manganese is present in the composition in an amount of from about 70 wt % to about 95 wt %;
b) cationic iron is present in the composition in an amount of from about 0.1 wt % to about 10 wt %; and/or
c) the cationic metal is present in the composition in an amount of from about 0.001 wt % to about 10 wt %.

14. The solid composition according to claim 12, wherein the oxide of manganese is selected from one or more of the group consisting of manganese (II) oxide, manganese (III) oxide and manganese (IV) oxide.

15. The solid composition according to claim 12, wherein the cationic iron species is an oxide of iron.

16. (canceled)

17. The solid composition according to claim 12, wherein the cationic metal species comprises cations selected from one or more of the group consisting of copper, lead, titanium, vanadium, aluminum, calcium, strontium, potassium, lithium, nickel, cobalt and cerium.

18. The solid composition according to claim 12, wherein the cationic metal species comprises cations selected from two preferably three, or more of the group consisting of copper, lead, titanium, vanadium, aluminum, calcium, strontium, potassium, lithium, nickel, cobalt and cerium.

19. (canceled)

20. The solid composition according to claim 12, comprising cationic copper, lead, titanium, vanadium, aluminum, calcium, strontium, and potassium.

21. The solid composition according to claim 20, wherein:
the oxide of manganese is present in the composition in an amount of from about 70 wt % to about 95 wt %;
cationic iron is present in the composition in an amount of from about 0.1 wt % to about 10 wt %;
cationic copper is present in the composition in an amount of from about 0.01 wt % to about 10 wt %;
cationic lead, titanium, vanadium, and strontium are each present in the composition in an amount of from about 0.001 wt % to about 1 wt %; and
cationic aluminum, calcium and potassium are each present in the composition in an amount of from about 0.01 wt % to about 5 wt %.

22. The solid composition according to claim 12, wherein the composition is in the form of granules.

23. The solid composition according to claim 22, wherein the granules are:
a) characterizable by a particle size diameter in the range of about 0.01 mm to about 2 mm; and/or
b) characterizable by a BET surface area in the range of about 10 m²/g to about 25 m²/g.

24-31. (canceled)

32. A method for treating water containing contaminants, comprising contacting contaminated water with a solid composition according to claim 12.

33. (canceled)
